(19) United States
(12) Patent Application Publication
(10) Pub. No.: US 2007/0294942 A1
(43) Pub. Date: Dec. 27, 2007

(54) Use of Nanostructured Metal Catalysts for the Production of Syngas and Hydrogen-Rich Gaseous Mixtures

(75) Inventors: Paolo Bert, Como (IT); Claudio Bianchini, Firenze (IT); Paolo Fornasiero, Trieste (IT); Mauro Graziani, Trieste (IT); Tiziano Montini, Sagrado (IT); Rinaldo Psaro, Segrate (IT); Vladimiro Dal Santo, Milano (IT); Alessandro Tampucci, Collesalvetti (IT); Francesco Vizza, Firenze (IT)

Correspondence Address: WILLIAM COLLARD;COLLARD & ROE, P.C., 1077 NORTHERN BOULEVARD, ROSLYN, NY, 11576, US

(73) Assignee: ACTA. S.P.A.

(21) Appl. No.: 11/666,588

(22) PCT Filed: Sep. 16, 2005
(86) PCT No.: PCT/EP05/54619

§ 371 Date: Apr. 27, 2007

(30) Foreign Application Priority Data
Oct. 27, 2004 (IT) FI2004A000220

(51) Int. Cl. C01B 3/22

(52) U.S. Cl. 48/198.7

(57) ABSTRACT

It is herein described the use of nanostructured metal catalysts for the production of syngas and hydrogen-rich gaseous mixtures; the catalysts are constituted by nanostructured metal particles obtained by reduction of metal complexes formed of metal salts and template polymers, whose molecular weight ranges from 1000 to 50000 g mol⁻¹ prepared by condensation of a 4-{1-[(phenyl-2,4-disubstituted)-hydrazono-alkyl}-benzene-1,3-diol with phenol, or a 3,5 disubstituted phenol, and formaldehyde, or para-formaldehyde in the presence of an acid or basic catalyst in water/alcohol mixtures at temperatures between 20 and 150° C.

### FIELD OF THE INVENTION

This invention refers to the field of production of syngas or hydrogen-rich gaseous mixtures, and particularly to the use of nanostructured metal catalysts, which will be later described, for the production of such gases or gaseous mixtures, by reforming of hydrocarbons and alcohols for instance, or else by alcohols decomposition.

### STATE OF THE ART

Hydrogen and syngas are usually produced by catalyzing reforming reactions of organic compounds: hydrocarbons and alcohols are the most used. For the production of gaseous mixture containing hydrogen, partial oxidation reactions with O₂, steam reforming or autothermal reforming may be employed. Otherwise, methanol decomposition can be used.

The production of syngas from hydrocarbons is a well-known and consolidated process, yet the use of these gases for new applications, such as feeding gas for fuel cells, requires the development of catalytic systems much more efficient than those presently in use, in order to reduce working temperatures. For this reason, Ni based catalysts or noble metals (mostly Pt and Rh) based catalysts, usually supported on oxide materials are commonly studied.

The use of ethanol as raw material for the production of hydrogen-rich gaseous mixtures is advantageous in that it makes use of a renewable energetic resource: ethanol is the natural product of biomasses fermentation. The use of a renewable resource means a relevant progress as far as environment is concerned, since it allows natural carbon cycle to be closed. A procedure for the production of hydrogen and electricity using a steam reforming process of ethanol obtained by fermentation of biomasses has been recently described. Reforming reactions for methanol are generally carried out on Cu based catalysts in the presence of a variety of materials that act either as supports or as promoters (for example, ZnO, Al₂O₃, ZrO₂, CeO₂, Ni, Co). An alternative to such catalysts is provided by metal catalysts (such as Ni, Co or noble metals like Rh) supported on oxide materials, which have been long studied and described in some patents.

Methanol decomposition is usually carried out on Cu based catalysts with several kinds of supports/promoters or on Pd based materials.

Catalysts for reforming reactions are usually prepared in two different ways:
By impregnation of a preformed support with a metal salt or a metal compound, followed by calcination of the resulting material in order to decompose the precursor to the active phase and eventually by reduction, or
By co-precipitation of the precursors to the active metallic phase and of the support material, calcinations and eventually reduction of the resulting material. The second alternative, often called “Solid Phase Crystallization”, has been employed for the production of reforming catalysts for both methane and alcohols (see F. Basile et al. J. Catal. 2003, 217, 245).

As for hydrocarbons and alcohols reforming reactions, it has been noticed that in many cases the presence of a bimetallic phase, better if it is arranged in an alloy, promotes the formation of syngas or hydrogen-rich gaseous mixtures (see for example J. P. Shen et al. Catal. Today 2002, 77, 89). It has been also noticed that by making alloys it is possible to modify the characteristics of the catalyst, inhibiting those undesired reactions which induce its deactivation, like the formation of coke on Ni based catalysts (see for example F. Besenbacher et al. Science 1998, 279, 1913).

In general, catalysts used in reforming reactions of alcohols contain high percentages of the active phase in order to achieve the performance necessary for their employment. All this contributes to limit their large scale diffusion and use. As a matter of fact, a high percentage of the active phase makes the catalyst very expensive, especially if it contains noble metals.

Moreover, in order to maximize the selectivity towards the production of hydrogen-rich gaseous mixtures and inhibit parasitic reactions, it turns out to be extremely important to obtain a nanostructured active metal phase. It has been proved indeed that on Co based catalysts, the smaller crystals sizes, the more selective the catalyst towards hydrogen production in reaction of ethanol steam reforming (F. Haga et al. React Kin. Catal. Lett. 1998, 63, 253). To preserve such nanostructure is very important for the development of efficient and long-life reforming catalysts, because of the relatively high temperatures they work at. Good results have been achieved by the “Solid Phase Crystallization” method, previously cited (see for example F. Basile et al. J. Catal. 2003, 217, 245). As an alternative, it has been reported the preparation of a stable reforming catalyst which has been obtained by means of a sol-gel technique mediated by microemulsion (J. Schicks et al. Cat. Today 2003, 81, 287). All these examples, however, show a common flaw, i.e. the request for a huge quantity of noble metals (Rh or Pt), which makes their use disadvantageous.

In the International Patent Request N^{o}. WO 2004/036674 templating polymers are described, which have been produced by condensation of a 4-{1-[(phenyl-2,4-disubstituted)-hydrazono-alkyl}-benzene-1,3-diol with phenol, or a 3,5 disubstituted phenol, and formaldehyde, or para-formaldehyde, and are able to coordinate platinum-free metal salts, preferably salts or compounds containing Fe, Co and/or Ni, to give adducts that, once reduced either with gaseous hydrogen or with other reducing agents or pyrolyzed under an inert atmosphere at temperatures higher than 500° C. yield catalytic materials with relevance to fuel cells fuelled with hydrogen or other compounds containing hydrogen atoms such as alcohols (methanol, ethanol, ethylene glycol), aldehydes, hydrazine and even hydrocarbons.

Further studies have shown that metal particles contained in such catalytic materials, no matter how many metals they are made up of, are very small, with sizes ranging between 3 and 50 Å (10⁻¹⁰ m).

Catalysts formed of highly scattered subnanometric or nanometric particles (10⁻⁹ m) have been described in the Italian Patent application N^{o}. FI20040000154 which refers in particular to the preparation, by means of the templating polymers described in the International Patent application N^{o}. WO 2004/036674, of Pd or Pt based catalysts combined with other transition metals for the production of catalytic materials for anode and cathode electrodes for fuel cells working with hydrogen or compounds containing hydrogen atoms.

### SUMMARY OF THE INVENTION

The Applicant has now found out that the catalysts already described in the International Patent application N^{o}. WO 2004/036674 can be used with great profit for the production of syngas and hydrogen-rich gaseous mixtures. The object of this invention is therefore the use of nanostructured metal catalysts in a process for the preparation of syngas and hydrogen-rich gaseous mixtures: these catalysts are produced from metal complexes and templating polymers, whose molecular weight ranges from 1000 to 50000 g mol⁻¹ prepared by condensation of a 4-{1-[(phenyl-2,4-disubstituted)-hydrazono-alkyl}-benzene-1,3-diol with phenol, or a 3,5 disubstituted phenol, and formaldehyde, or para-formaldehyde in the presence of an acid or basic catalyst in water/alcohol mixtures at temperatures between 20 and 150° C.

A further object of the invention is a process for the production of syngas and gaseous hydrogen-rich mixtures by means of one of the following reactions: alcohol decomposition, partial oxidation of an alcohol or hydrocarbon, steam reforming and autothermal reforming of an alcohol or of an hydrocarbon; in this process, the reaction is carried out in the presence of a catalyst like those described above, at a temperature comprised between 150 and 800° C., in a quantity which varies from 0.1 to 10% in weight with respect to the support, and at a space velocity between 10.000 and 800.000 ml g⁻¹ h⁻¹. Characteristics and advantages of this invention will be shown in detail in the following description.

### BRIEF DESCRIPTION OF THE DRAWINGS

FIG. 1 shows how the percentage conversion of methanol to H₂, CO, CO₂ and CH₄, and the yields of such gases vary with the temperature in the course of the decomposition of methanol to syngas catalyzed by a Fe, Co, Ni trimetallic catalyst, as described in Example 8.

FIG. 2 shows how the percentage conversion of methanol to H₂, CO, CO₂ and CH₄, and the yields of such gases vary with the temperature in the course of the decomposition of methanol to syngas catalyzed by a Fe, Co, Ni trimetallic catalyst, as described in Example 9.

FIG. 3 shows how the percentage conversion of ethanol to H₂, CO, CO₂ and CH₄ and the yields of such gases vary with the temperature in the steam reforming of ethanol to syngas catalyzed by a trimetallic Fe—Co—Ni catalyst as described in Example 10.

FIG. 4 shows how the percentage conversion of methane to H₂, CO, CO₂ and the yields of such gases vary with the temperature in the partial oxidation of methane to syngas catalyzed by a trimetallic Fe—Co—Ni catalyst as described in Example 11.

FIG. 5 shows how the percentage conversion of methane to H₂, CO, CO₂ and the yields of such gases vary with the temperature in the partial oxidation of methane to syngas catalyzed by a Rh based catalyst as described in Example 12.

### DETAILED DESCRIPTION OF THE INVENTION

The catalysts of the invention are made up of metal complexes formed of metal salts, preferably chosen among the group which comprises Ni, Co, Fe, Ru, Rh, Pt, Pd, Mo, Ir, Cu, Sn and their binary, ternary or quaternary combination, and templating polymers (already described in the patent application WO 2004/036674), with a molecular weight between 1.000 and 50.000 g mol⁻¹ and obtained by condensation of a 4-{1-[(phenyl-2,4-disubstituted)-hydrazono-alkyl}-benzene-1,3-diol with phenol, or a 3,5 disubstituted phenol, and formaldehyde, or para-formaldehyde in the presence of an acid or basic catalyst in water/alcohol mixtures at temperatures between 20 and 150° C. The 4-{1-[(phenyl-2,4-disubstituted)-hydrazono-alkyl}-benzene-1,3-diol is preferably a compound with the following general formula (A): 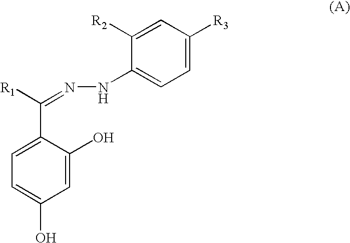
where R₁ is chosen among the group which comprises H and hydrocarbon radicals containing from 1 to 10 carbon atoms, eventually bearing halogen atoms; R₂ and R₃, equal or different from each other, are H or a group chosen among the group which comprises halide, nitro, acyl, ester, carboxylic acid, formyl, nitrile, sulfonic acid, aryl groups, or linear alkyls or branched alkyls containing from 1 to 15 carbon atoms, eventually functionalized with halogen atoms or condensed with each other so as to form one or more than one condensed cycles with the phenyl ring.

The term “phenol” or “3,5-disubstituted phenol” denotes preferably a compound with the following general formula (B): 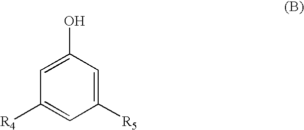
where R₄ and R₅, equal or different from each other, are H or a group chosen among the group which comprises OH, ether, amine, aryl groups and linear or branched alkyls containing from 1 to 15 carbon atoms.

Said polymers of the invention can be represented by the following repetitive unit with formula (C): 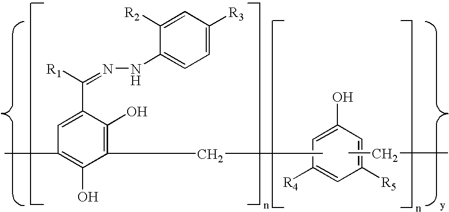
where y ranges between 2 and 120, x between 1 and 2, n between 1 and 3 and R₁, R₂, R₃, R₄ e R₅ are defined as above.

The “metal salts” of the invention are salts chosen among the group which comprises carboxylates, halides, pseudo-halides, alcoholates, acetylacetonates, formates, oxalates, malonates and analogous organic salts and their mixtures, or carbonates, oxides, bicarbonates or their mixtures.

For the preparation of the catalysts described in the invention, which will be used for the production of syngas by reforming of hydrocarbons or alcohols, methods 1, 2 and 3, that shall be described below, can be indifferently used.

Method 1:

A salt or a compound of a metal, preferably chosen among those mentioned above, is dissolved in water and the resultant solution is added to an aqueous suspension containing a templating polymer of known art which has been defined above and described in WO 2004/036674, which will be named POLYMER for sake of brevity. The mixture is brought to pH 8-9, by adding an appropriate amount of a 1 M solution of NaOH, and then vigorously stirred for 10-15 hours at ambient temperature. The solid product this way obtained, called MONO-METALLIZED POLYMER, is filtered off, washed with water and dried. The dry solid is added to a suspension of a porous metal oxide, suitably activated, like silica, alumina or ceria, in acetone or another organic solvent.

After stirring for a few hours, the product is treated with a reducing agent of the state of the art (for example, NaBH₄ or NH₂NH₂), filtered, washed with water and dried.

Alternatively, the solid product obtained from the reaction of the MONO-METALLIZED POLYMER with a porous metal oxide, preferably silica, alumina, ceria or zirconia or a combination of theirs, is isolated by evaporation of the solvent at reduced pressure and then heated in a flow of hydrogen gas at a temperature between 300 and 800° C.

Method 2:

Two salts or metal compounds, preferably chosen among those mentioned before, are dissolved in water and the resultant solution is added to an aqueous suspension containing the POLYMER. The mixture is brought to pH 8-9 by adding an appropriate amount of a 1 M solution of NaOH and then vigorously stirred for 10-15 hours at ambient temperature. The solid product this way obtained, called BI-METALLIZED POLYMER, is filtered off, washed with water and dried. This solid is added to a porous metal oxide, suitably activated, like silica, alumina or ceria, in acetone or another organic solvent. After stirring for a couple of hours, a reducing agent of the state of the art, like NaBH₄ or NH₂NH₂, is added in excess. The solid product is filtered, washed and dried.

Alternatively, the solid product obtained by reaction of a porous metal oxide, preferably alumina, silica, ceria or zirconia or a combination of theirs, with the BI-METALLIZED POLYMER, preferably containing, among the metals mentioned above, two metals chosen among Fe, Co and Ni, or among Cu, Co and Ni, is isolated by solvent evaporation under reduce pressure and then treated with a flow of hydrogen gas at a temperature between 300 and 800° C.

Method 3:

Three metal salts or metal compounds, preferably chosen among those mentioned before, are dissolved in water and the resultant solution is added to an aqueous suspension containing POLYMER. The mixture is brought to pH 8-9 by adding an appropriate amount of a 1 M solution of NaOH and then vigorously stirred for 10-15 hours at ambient temperature. The solid product obtained, called TRI-METALLIZED POLYMER, is filtered off, washed with water and dried. This solid is added to the suspension of a porous metal oxide, suitably activated, like silica, alumina or ceria, in acetone or another organic solvent, and then treated in situ with a reducing agent of the state of the art (like NaBH₄ or NH₂NH₂). The solid product obtained is filtered, washed and dried. Alternatively, the solid product obtained by the reaction of a porous metal oxide, preferably alumina, silica, ceria or zirconia or a combination of theirs, with the TRI-METALLIZED POLYMER, preferably containing Fe, Co and Ni, or Cu, Co and Ni, is isolated by solvent evaporation under reduced pressure and then treated with a flow of hydrogen gas at a temperature comprised between 300 and 800° C. An analogous procedure can be followed to prepare catalysts with more than three different metals, supported on the same material.

According to a particularly preferred embodiment of the invention, catalysts that have been produced with the methods described above are made up of a trimetallic combination of Fe, Co and Ni or of Cu, Co and Ni, arranged in variable stoichiometric ratios, preferably in equivalent atomic percentages, or else they can be made up of just Rh, supported on porous metal oxides, preferably Al₂O₃. They are capable to promote the production of syngas or hydrogen-rich gaseous mixtures via reforming reactions (partial oxidation, steam reforming or autothermal reforming) of hydrocarbons or alcohols, or else methanol decomposition. With respect to the catalysts commonly used for the production of hydrogen-rich gaseous mixtures, the following benefits can be achieved:
use of a catalyst with a low metal loading (up to 0.5-3% in weight with respect to the metal-support assembly)
use of non noble and low cost metals
opportunity to design and develop polymetallic catalysts in precise stoichiometric ratios between the chosen metals.

On the basis of these advantages, this invention allows the production of efficient catalysts for the reforming of hydrocarbons and alcohols and for the decomposition of hydrocarbons and alcohols at a remarkably lower costs than those presently employed.

According to this invention, the catalytic activity is tested by leading the reaction mixture on a catalytic bed, loaded in a quartz U-shaped reactor, introduced in an electric furnace. A thermocouple is placed into the catalytic bed to measure the real catalyst temperature. The transport line to the reactor is heated up to 110° C. to allow the complete evaporation of the liquid reagents. The transport gas may contain O₂ in case one wishes to study an oxidative reforming or an “autothermal reforming”. Before having catalytic activity measured, the catalysts are reduced in pure H₂ (10 ml/min) at 370° C. for 30 minutes. The reaction mixture is prepared by injecting a liquid mixture of alcohol and water in the chosen ratio by means of an inert gas (Ar), making use of an automatic pump syringe. The amount of catalyst as well as the gaseous mixture flow is chosen to get the desired space velocity (GHSV). The reaction mixture is introduced into the reactor at a temperature of 150° C. One hour later, the oven temperature is increased to 800° C. at a 1° C./min rate. Outcoming gaseous mixture composition is analyzed by gas chromatography. The amounts of alcohol, CO, CO₂ and methane are determined with a Carboxen 1006 PLOT column (30 m×0.53 mm ID), using He as carrier, connected in series to a methanizer and to a flame ionization detector (FID). The amount of produced hydrogen is determined with a Molsieve 5A column (25 m×0.53 mm ID) using Ar as carrier and connected to a thermo-conductivity detector (TCD). The catalytic activity is evaluated by reporting the alcohol conversion and the H₂, CO, CO₂ and CH₄ yields in function of the catalyst temperature. The following examples are herein enclosed to illustrate this invention, without endangering anyway its generality.

### EXAMPLE 1

### Preparation of a Rh Based Catalyst Supported on Al₂O₃

0.3 g of rhodium trichloride hydrate (Aldrich) dissolved in 20 ml of water were added to a suspension of 1 g of POLYMER in 100 ml of water. The mixture was brought to pH 9 by adding 50 ml of NaOH 1 M, and vigorously stirred at ambient temperature for 12 hours. A dark red precipitate was formed, which was filtered off, washed several times with water and dried under reduced pressure at 70° C. until constant weight; 1 g of product was obtained, which ICP-AES analysis showed to contain 4.5 wt % Rh. To a sonicated suspension of 0.25 g of the latter product in 200 ml of acetone, were added 2 g of activated Al₂O₃ suspended in 100 ml of acetone and sonicated for 20 min. The resultant suspension was vigorously stirred at ambient temperature for 4 hours. Eventually, it was cooled to 0° C., and 1.5 g of NaBH₄ were added in small portions. The resultant mixture was left standing at ambient temperature and two hours later the solid residue was filtered off, washed several times with water (3×50 ml) and dried under reduced pressure at 70° C. until constant weight. ICP-AES analysis showed this product to contain 0.85 wt % Rh.

### EXAMPLE 2

### Preparation of a Rh Based Catalyst Supported on Al₂O₃

The preparation of Example 1 was repeated with analogous results, by carrying out the reduction with hydrogen gas. In this case, 1 g of solid product containing POLYMER-Rh—Al₂O₃ was introduced into a quartz reactor and heated up in a hydrogen flow at 360° C. for 1 hour. Then, the sample was stored under N₂.

### EXAMPLE 3

### Preparation of a Trimetallic Fe, Co and Ni Based Catalyst Supported on Al₂O₃

An aqueous solution (150 ml) containing 1.59 g of cobalt(II) acetate tetrahydrate (Aldrich), 1.59 g of nickel(II) acetate tetrahydrate (Aldrich) and 1.17 g of iron(II) acetate (Aldrich) was added to a suspension of 7 g of POLYMER in 200 ml of water. The mixture was brought to pH 9 by adding 100 ml of NaOH 1 M and energetically stirred for 15 hours at ambient temperature. A dark red precipitate was formed, which was filtered off, washed several times with water and dried under reduced pressure at 70° C. until constant weight; 8 g of product were obtained, which ICP-AES analysis showed to contain Co 4.27%, Ni 4.31% and Fe 3.98% in weight. To a sonicated suspension of 0.25 g of the latter product in 200 ml of acetone were added 2 g of activated Al₂O₃ suspended in 100 ml of acetone after being sonicated for 20 min. The resultant suspension was energetically stirred at ambient temperature for 4 hours. Eventually, it was cooled to 0° C., and 1.8 g of NaBH₄ were added in small portions. The mixture was left standing at ambient temperature, and 2 hours later the solid residue was filtered off, washed several times with water (3×50 ml) and dried in under reduced pressure at 70° C. until constant weight. ICP-AES analysis showed this product to contain Co 0.85%, Ni 0.86%, Fe 0.79% in weight. Percentage atomic ratio: CO₃₄Ni₃₄Fe₃₂.

### EXAMPLE 4

### Preparation of a Trimetallic Fe, Co and Ni Based Catalyst Supported on Al₂O₃

The preparation of Example 3 was repeated with analogous results by carrying out the reduction with hydrogen gas. In this case, 1 g of solid product containing POLYMER-Co—Ni—Fe—Al₂O₃ was introduced into a quartz reactor and heated up in a flow of hydrogen at 360° C. for 1 hour. Then, the sample was stored under N₂.

### EXAMPLE 5

### Preparation of a Bimetallic Co and Ni Based Catalyst Supported on SiO₂

An aqueous solution (150 ml) containing 1.59 g of cobalt(II) acetate tetrahydrate (Aldrich) and 1.59 g of nickel(II) acetate tetrahydrate (Aldrich) was added to a suspension of 7 g of POLYMER in 200 ml of water. The mixture was brought to pH 9 by adding 100 ml of NaOH 1 M and energetically stirred for 15 hours at ambient temperature. A dark red precipitate was formed, which was filtered off, washed several times with water and dried under reduced pressure at 70° C. until constant weight; 7.5 g of product were obtained, which ICP-AES analysis showed to contain Co 4.27% and Ni 4.31% in weight.

To a sonicated suspension of 0.25 g of the latter product in 200 ml of acetone were added 2 g of activated SiO₂ suspended in 100 ml of acetone after being sonicated for 20 min. The resultant suspension was vigorously stirred at ambient temperature for 4 hours. Eventually, it was cooled to 0° C., and 1.2 g of NaBH₄ were added in small portions. The mixture was left standing at ambient temperature and 2 hours later the solid residue was filtered off, washed several times with water (3×50 ml) and dried under reduced pressure at 70° C. until constant weight. ICP-AES analysis showed this product to contain Co 0.85% and Ni 0.86% in weight. Percentage atomic ratio: CO₅₀Ni₅₀.

### EXAMPLE 6

### Preparation of a Bimetallic Co and Ni Based Catalyst Supported on SiO₂

The preparation of Example 5 was repeated with analogous results by carrying out the reduction with hydrogen gas. In this case, 1 g of solid product containing POLYMER-Ni—Co—SiO₂ was introduced into a quartz reactor and heated up in hydrogen flow at 360° C. for 1 hour. Then, the sample was stored under N₂.

### EXAMPLE 7

### Preparation of a Trimetallic Cu, Co and Ni Based Catalyst Supported on Al₂O₃

An aqueous solution (150 ml) containing 1.75 g of cobalt(II) acetate tetrahydrate (Aldrich), 1.75 g of nickel(II) acetate tetrahydrate (Aldrich) and 1.82 g of copper(II) acetate monohydrate (Aldrich) was added to a suspension of 7 g of POLYMER in 200 ml of water. The mixture was brought to pH 9 by adding 100 ml of NaOH 1 M and energetically stirred for 15 hours at ambient temperature. A red brown precipitate was formed, which was filtered off, washed several times with water and dried under reduced pressure at 70° C. until constant weight; 8 g of product were obtained, which ICP-AES analysis showed to contain Co 4.27%, Ni 4.31%, Cu 3.78% in weight. To a sonicated suspension of 0.25 g of the latter product in 200 ml of acetone were added 2 g of activated Al₂O₃ suspended in 100 ml of acetone after being sonicated for 20 min.

The resultant suspension was vigorously stirred at ambient temperature and 2 hours later the solid residue was filtered off, washed several times with water (3×50 ml) and dried in under reduced pressure at 70° C. until constant weight. ICP-AES analysis showed this product to contain Co 0.85%, Ni 0.86% and Cu 0.78% in weight. Percentage atomic ratio: CO₃₄Ni₃₄Cu₃₂.

### EXAMPLE 8

### Methanol Decomposition to Syngas with a Trimetallic Catalyst POLYMER-Fe—Co—Ni—Al₂O₃

This example shows the capability of a trimetallic catalyst POLYMER-Fe—Co—Ni—Al₂O₃ prepared as described in Example 3 to catalyze the decomposition of methanol to syngas.

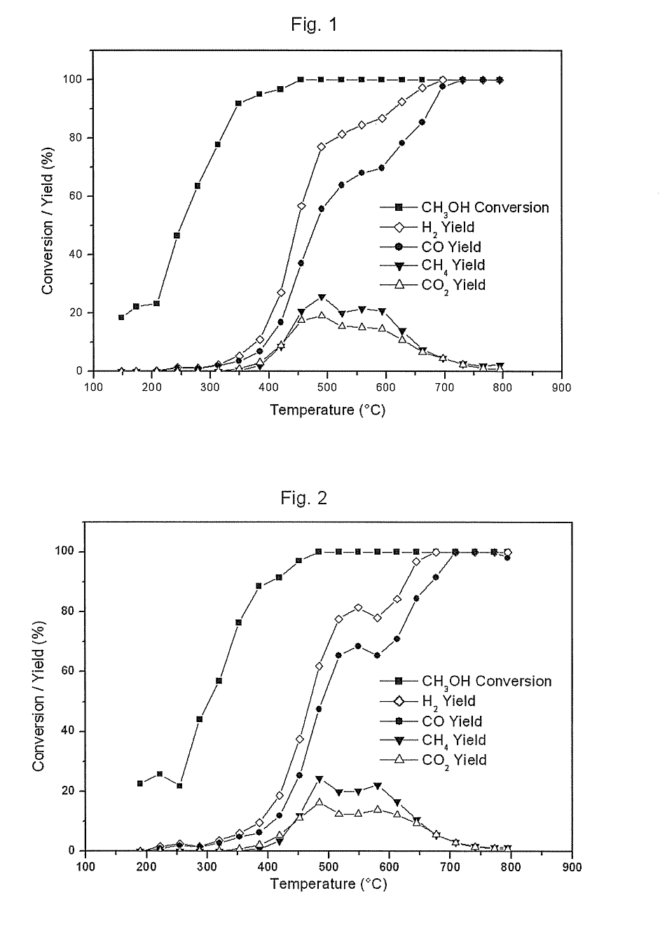

259.5 mg of trimetallic catalyst POLYMER-Co—Ni—Fe—Al₂O₃ prepared as in Example 3 were placed inside the reactor and were reduced again by means of a H₂ flow at 370° C. for 30 minutes. The catalytic activity was studied using a reaction mixture containing CH₃OH (2.0%)/Ar, which was prepared by injecting 2.0 μl/min of liquid CH₃OH in a 60.3 ml min⁻¹ flow of Ar. These conditions have been chosen to get a GHSV≈14000 ml g⁻¹ h⁻¹. The results obtained have been reported in FIG. 1, where one may notice that the CH₃OH conversion was complete around 450° C. At this temperature H₂ and CO were the main products, even though considerable quantities of CO₂ and CH₄ persisted. Over 750° C., the conversion to syngas (H₂+CO) was practically complete.

### EXAMPLE 9

### Methanol Decomposition to Syngas with a Trimetallic Catalyst POLYMER-Fe—Co—Ni—Al₂O₃

This example shows the capability of a trimetallic catalyst POLYMER-Fe—Co—Ni—Al₂O₃ prepared as described in Example 3 to catalyze the decomposition of methanol to syngas, at GHSV values greater than those reported in Example 8. 96.0 mg of trimetallic catalyst POLYMER-Fe—Co—Ni—Al₂O₃ prepared as in Example 3 were introduced in the reactor and reduced again with a H₂ flow at 370° C. for 30 minutes. The catalytic activity was studied using a reaction mixture containing CH₃OH (2.0%)/Ar, which was prepared by injecting 1.5 μl/min of liquid CH₃OH in a 44.3 ml min⁻¹ flow of Ar. These conditions were chosen to get a GHSV≈28.000 ml g⁻¹ h⁻¹. The results obtained are reported in FIG. 2. In these conditions, the results are comparable to those reported in FIG. 1 for Example 8.

### EXAMPLE 10

### Steam Reforming of Ethanol to Syngas with a Trimetallic Catalyst POLYMER-Fe—Co—Ni—Al₂O₃

This example shows the capability of a trimetallic catalyst POLYMER-Fe—Co—Ni—Al₂O₃, prepared as described in Example 3, to catalyze the steam reforming reaction of ethanol to syngas in stoichiometric conditions.

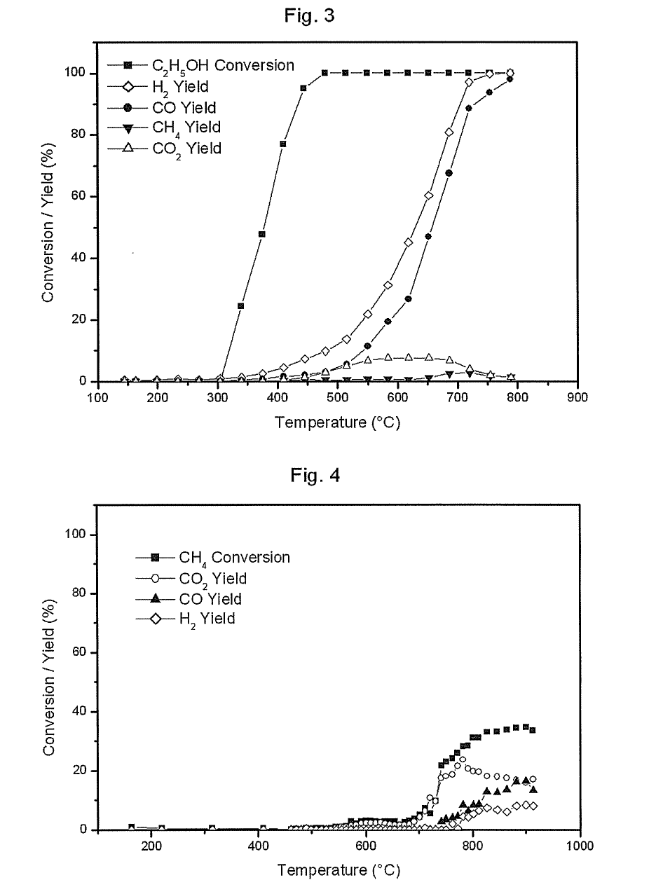

46.8 mg of a trimetallic catalyst POLYMER-Fe—Co—Ni—Al₂O₃, prepared as described in Example 3, were introduced in the reactor and reduced again with a H₂ flow at 370° C. for 30 minutes. The catalytic activity was studied by using a C₂H₅OH (1.0%)+H₂O (1.0%)/Ar mixture, prepared by injecting 2.5 μl/min of a liquid mixture of C₂H₅OH+H₂O in a molar ratio of 1:1 (C₂H₅OH 72.2%, H₂O 28.8% in weight) in a flow of 77.2 ml min⁻¹ of Ar. These conditions were chosen to get a GHSV≈100.000 ml g⁻¹ h⁻¹. The results obtained are reported in FIG. 3. In these conditions, ethanol conversion is complete around 480° C. H₂ began to form around 340° C. The H₂ production continued to increase until about 760° C., where the yield was 100%. At the same time, CO and CO₂ were formed, together with small amounts of CH₄, and around 800° C. syngas was nearly the only product.

### EXAMPLE 11

### Partial Oxidation of Methane to Syngas with a Trimetallic Catalyst POLYMER-Fe—Co—Ni—Al₂O₃

This example shows the capability of a trimetallic catalyst POLYMER-Fe—Co—Ni—Al₂O₃, prepared as described in Example 3, to catalyze the partial oxidation of methane to syngas in stoichiometric conditions.

14.1 mg of trimetallic catalyst POLYMER-Fe—Co—Ni—Al₂O₃, prepared as described in Example 3, were introduced in the reactor, calcined in a O₂ flow (5%)/Ar at 900° C. for 1 hour and reduced with a H₂ flow at 370° C. for 30 minutes. The catalytic activity was studied by using a CH₄ (2.0%)+O₂ (1.0%)/Ar mixture, prepared mixing appropriate flows of CH₄ (20%)/Ar, O₂ (15%)/Ar and Ar to get a 100 ml min⁻¹ total flow. These conditions were chosen to get a GHSV≈425.000 ml g⁻¹ h⁻¹. The results obtained are reported in FIG. 4. In these conditions, methane conversion started around 500° C., whereas H₂ production started around 800° C. At temperatures lower than 800° C., the only product was CO₂. At 900° C., the maximum conversion of methane was about 35% with a H₂ yield close to 10%.

### EXAMPLE 12

### Partial Oxidation of Methane to Syngas with a Catalyst POLYMER-Rh—Al₂O₃

This example shows the capability of Rh based catalyst, prepared as described in Example 1, to catalyze the partial oxidation of methane to syngas in stoichiometric conditions.

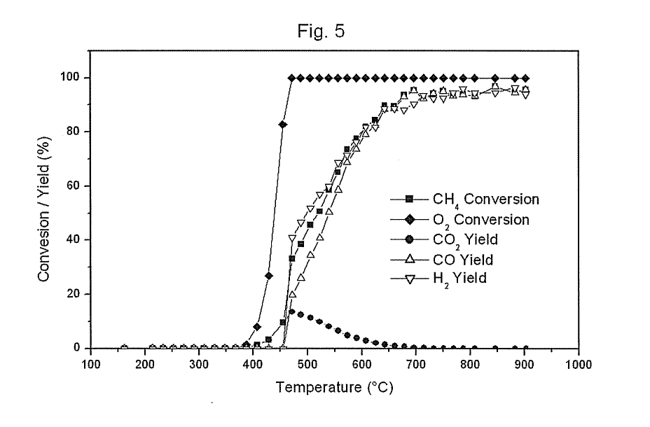

22.4 mg of catalyst POLYMER-Rh—Al₂O₃ (metal loading 1 wt %), prepared as described in Example 1, were introduced in the reactor and reduced with a H₂ flow at 370° C. for 30 minutes. The catalytic activity was studied using a CH₄ (2.0%)+O₂ (1.0%)/Ar mixture, prepared mixing appropriate CH₄ (20%)/Ar, O₂ (15%)/Ar and Ar flows to get a 120 ml min⁻¹ total flow. These conditions were chosen to get a GHSV≈320.000 ml g⁻¹ h⁻¹. The results obtained are reported in FIG. 5. In these conditions, the reaction started around 400° C. producing CO₂. When the O₂ conversion was 100% and the methane conversion overcame 25%, CO and H₂ production started as a result of the reforming of the residual CH₄ with H₂O and CO₂, which were produced out of CH₄ combustion. Above 700° C., the reactivity of the system was constant with a conversion of CH₄ close to 95% and syngas production.

1-24. (canceled)

25: Process for the preparation of syngas and hydrogen-rich gaseous mixtures by reforming of hydrocarbons and alcohols comprising nanostructured metal catalysts, which have been obtained by reduction of metal complexes constituted by salts of metals chosen in the group consisting of Ni, Co, Fe, Ru, Rh, Pt, Pd, Mo, Ir, Cu, Sn, and their binary, tertiary or quarternary combinations and template polymers with a molecular weight ranging from 1.000 and 50.000 g mol⁻¹, in turn obtained by condensation of a 4-{1-[(phenyl-2,4-disubstituted)-hydrazono-alkyl}-benzene-1,3-diol with phenol, or a 3,5 disubstituted phenol, and formaldehyde, or para-formaldehyde in the presence of an acid or basic catalyst in water/alcohol mixtures at temperatures between 20 and 150° C.

26: Process according to claim 25, where said process for the preparation of syngas and hydrogen-rich gaseous mixtures comprises alcohol decomposition.

27: Process according to claim 25, where said process for the preparation of syngas and hydrogen-rich gaseous mixtures comprises a partial oxidation reaction, or a steam reforming reaction, or an autothermal reforming reaction of an alcohol.

28: Process according to claim 25, where said process for the preparation of syngas and hydrogen-rich gaseous mixtures comprises a partial oxidation reaction, or a steam reforming reaction, or an autothermal reaction of a hydrocarbon.

29: Process according to claim 26, where said alcohol is chosen among ethanol or methanol.

30: Process according to claim 29, where said alcohol is methanol.

31: Process according to claim 27, where said alcohol is chosen among ethanol or methanol.

32. Process according to claim 30, where said alcohol is methanol.

33: Process according to claim 28, where said hydrocarbon is methane.

34: Process according to claim 25, where said nanostructured metal catalysts are the only catalysts of the reaction, and are supported on a suitable support, or else as promoters of reforming catalysts comprising Cu and ZnO, which may even comprise further supports and/or promoters.

35: Process according to claim 34, where said metals are chosen among Rh, bimetallic or trimetallic combinations of Fe, Co and Ni, and bimetallic or trimetallic combinations of Cu, Co and Ni.

36: Process according to claim 35, where said bimetallic or trimetallic combinations contain metals in the equivalent atomic percentages.

37: Process according to claim 34, where said “salts” are chosen among the group that comprises carboxlates, halides, pseudo-halides, alcoholates, acetylacetonates, formates, oxalates, malonates and analogous organic salts and their mixtures, or carbonates, oxides, bicarbonates or their mixtures.

38: Process according to claim 25, where said 4-{1-[(phenyl-2,4-disubstituted)-hydrazono-alkyl}-benzene-1,3-diol is a compound with the following general formula (A): 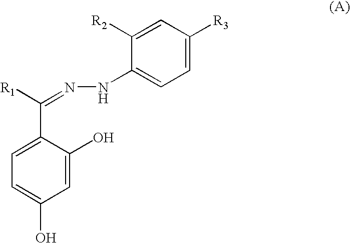
where R₁ is chosen among the group which comprises H and hydrocarbon radicals containing from 1 to 10 carbon atoms, possibly bearing halogen atoms;
R₂ and R₃, equal or different from each other, are H or a group chosen among the group which comprises halogen, nitro, acyl, ester, carboxylic acid, formyl, nitrile, sulfonic acid, aryl groups, or linear alkyls or branched alkyls containing from 1 to 15 carbon atoms, possibly functionalized with halogen atoms or condensed with each other so as to form one or more than one condensed cycles with the phenyl ring.

39: Process according to claim 25, where said phenol or 3,5-disostituted phenol is a compound with the following general formula (B): 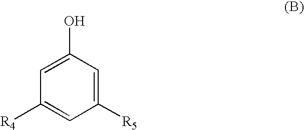
where R₄ and R₅, equal or different from each other, are H or a group chosen among the group which comprises OH, ether, amine, aryl groups and linear or branched alkyls containing from 1 to 15 carbon atoms.

40: Process according to claim 25, where said template polymers comprise the following repetitive unit with formula (C): 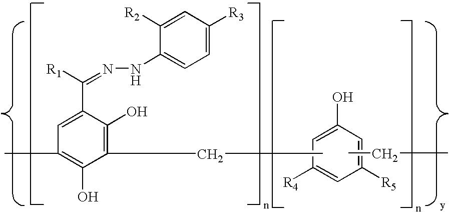
where y ranges from 2 to 120, x from 1 and 2, n from 1 to 3, R₁ is chosen among the group which comprises H and hydrocarbon radicals containing from 1 to 10 carbon atoms, possibly bearing halogen atoms, R₂, and R₃ are equal or different from each other, are H or a group chosen among the group which comprises halogen, nitro, acyl, ester, carboxylic acid, formyl, nitrile, sulfonic acid, aryl groups, or linear alkyls or branched alkyls containing from 1 to 15 carbon atoms, possibly functionalized with halogen atoms or condensed with each other so as to form one or more than one condensed cycles with the phenyl ring, and R₄ and R₅ are equal or different from each other, are H or a group chosen among the group which comprises OH, ether, amine, aryl groups and linear or branched alkyls containing from 1 to 15 carbon atoms.

41: Process according to claim 25, where said metal catalysts are supported on porous metal oxides.

42: Process according to claim 41, where said porous metal oxides are chosen among the group that comprises alumina, silica, ceria, zirconia, magnesia, and combination of theirs.

43: Process according to claim 41, where said porous metal oxides are aluminas.

44: Process according to claim 41, where said metal catalysts supported on porous oxides have a metal loading between 0.1 and 50% in weight with respect to the total weight of the supported catalyst.

45: Process according to claim 44, where said metal loading is between 0.5 and 3% in weight with respect to the total weight of the supported catalyst.

46: Process according to claim 25, where said metal catalysts are made up of highly dispersed metal particles, with dimensions between 3 and 70 Å.

47: Process for the production of syngas and hydrogen-rich gaseous mixtures involving a reaction chosen among alcohol decomposition, alcohol or hydrocarbon partial oxidation, alcohol or hydrocarbon steam reforming or autothermal reforming wherein such reaction is carried out in the presence of a catalyst as in claim 1, at a temperature between 150 and 800° C., with a metal loading comprised between 0.1 and 10% in weight with respect to the support, and at a space velocity between 10.000 and 800.000 ml g⁻¹ h⁻¹.

48: Process according to claim 47, where said alcohol is chosen among ethanol and methanol and said hydrocarbon is methane.

49: Process according to claim 48, where said alcohol is methanol.
